(19) United States
(12) Patent Application Publication
(10) Pub. No.: US 2012/0197655 A1
(43) Pub. Date: Aug. 2, 2012

(54) AIDING USER SELECTION OF A TREATMENT OPTION FOR A HEALTH CARE ISSUE

(76) Inventors: Shub DEBGUPTA, Washington, DC (US); Praveen Mooganur, Falls Church, VA (US)

(21) Appl. No.: 13/015,176

(22) Filed: Jan. 27, 2011

(51) Int. Cl. G06Q 50/00

(52) U.S. Cl. 705/2

(57) ABSTRACT

There is provided a support platform and method that enables a individual to make a health care decision. This platform and method provides comparison information to the individual that allows the individual to compare various treatment options for treating health care issue(s). This comparison information includes information for each of the plurality of treatment options gathered from a plurality of individuals that used at least one of the plurality of treatment options in treating the healthcare issue. This comparison information also includes, for at least one of the plurality of treatment options, information associated with the individual regarding healthcare services provided to the individual.

### BACKGROUND

1. Field of the Invention

The present invention relates to generally to health care, and more particularly to providing health care information to a user of health care services.

2. Related Art

The decisions an individual makes regarding their health can have a very significant impact. For example, an individuals health choices and actions not only impact the individuals personal well being, but also the out-of-pocket costs of the individual and their productivity. This in turn can have an impact on the individual employer and co-workers. The decisions making process used in selecting treatment options by the individual can thus influence a number of different things.

Until recently the information available to individual attempting to make decision regarding their health care was very limited. For example, the individual was limited to the information provided by their doctor(s), friends, or other individuals. Or, they could attempt to read medical articles or information available in books or periodicals (e.g., medical journals)

With the advent of the Internet, individuals can more readily access medical information for which they previously had to obtain from a book or magazine. These websites typically provide general information about health care issues, such as how to diagnose a particular issue and treatment otions available. These websites, however, often provide the information in a manner that is often confusing to the individual and leaving the individual uncertain and unnecessarily concerned about the best mechanism for treating their particular health care issue.

This confusion can result in the individual seeking unnecessary or more expensive treatment options that increase health care costs for both the individual and their employer. In addition to increasing costs, this confusion can also result in increased absence and decreased productivity of the individual further increasing costs to the individual's employer.

### SUMMARY

In one aspect of the present invention, there is provided a method for providing healthcare information to a user, the method comprising: receiving, via a network, authentication information identifying the user as a customer of health care services associated with a particular entity; associating the user with the particular entity if the authentication information corresponds to stored authentication information associating the user with the particular entity; receiving from the user, via the network, information identifying a healthcare issue; and generating a user interface to be displayed to the user, via the network, wherein the user interface comprises comparison information regarding the health care issue to enable the user to make a decision regarding selecting a treatment option from a plurality of treatment options for treating the healthcare issue; and wherein the comparison information comprises information for each of the plurality of treatment options gathered from a plurality of individuals that used at least one of the plurality of treatment options in treating the healthcare issue such that the comparison information enables the user to compare the plurality of treatment options; and wherein at least one of the plurality of treatment options is provided via healthcare services provided by the entity, and wherein the user interface further comprises information regarding the healthcare services provided to the user by the entity.

In another aspect, there is provided a system configured to provide healthcare information to a user, the system comprising: a storage containing authentication information identifying the user as a customer of health care services associated with a particular entity, information regarding a plurality of treatment options for a health care issue and comparison information to enable the user to compare the plurality of treatment options; a network interface configured to connect to a network and receive, via the network, the authentication information from the user; and a processor configured to associate the user with the particular entity if the received authentication information corresponds to the stored authentication information, receiving from the user, via the network interface, information identifying a healthcare issue, and generate a user interface to be displayed to the user, via the network, wherein the user interface comprises comparison information regarding the health care issue to enable the user to make a decision regarding selecting a treatment option from a plurality of treatment options for treating the healthcare issue; and wherein the comparison information comprises information for each of the plurality of treatment options gathered from a plurality of individuals that used at least one of the plurality of treatment options in treating the healthcare issue such that the comparison information enables the user to compare the plurality of treatment options; and wherein at least one of the plurality of treatment options is provided via healthcare services provided by the entity, and wherein the user interface further comprises information regarding the healthcare services provided to the user by the entity.

In yet another aspect, there is provided a system for providing healthcare information to a user, the system comprising: means for receiving, via a network, authentication information identifying the user as a customer of health care services associated with a particular entity; means for associating the user with the particular entity if the authentication information corresponds to stored authentication information associating the user with the particular entity; means for receiving from the user, via the network, information identifying a healthcare issue; and means for generating a user interface to be displayed to the user, via the network, wherein the user interface comprises comparison information regarding the health care issue to enable the user to make a decision regarding selecting a treatment option from a plurality of treatment options for treating the healthcare issue; and wherein the comparison information comprises information for each of the plurality of treatment options gathered from a plurality of individuals that used at least one of the plurality of treatment options in treating the healthcare issue such that the comparison information enables the user to compare the plurality of treatment options; and wherein at least one of the plurality of treatment options is provided via healthcare services provided by the entity, and wherein the user interface further comprises information regarding the healthcare services provided to the user by the entity.

### BRIEF DESCRIPTION OF THE DRAWINGS

By way of example only, embodiments of the invention are now described with reference to the accompanying drawings:

FIG. 1 illustrates an exemplary system by which a user may access information for making a decision regarding a treatment option for a health care issue, in accordance with an embodiment of the invention;

FIG. 2 provides a flow chart of an exemplary method for providing health care information to an individual, in accordance with an embodiment of the present invention;

FIG. 3 illustrates an exemplary webpage that an individual may use to select a particular health care issue associated with a particular health care topic, in accordance with an embodiment of the present invention;

FIG. 4 illustrates an exemplary webpage that may be displayed to an individual seeking to make a health care decision regarding a selected health care issue, in accordance with an embodiment of the present invention;

FIG. 5 illustrates an exemplary Compare webpage that may be displayed to an individual seeking to make a health care decision regarding a selected health care issue, in accordance with an embodiment of the present invention;

FIG. 6 illustrates another exemplary Compare webpage that may be displayed to an individual seeking to make a health care decision regarding a selected health care issue, in accordance with an embodiment of the present invention;

FIG. 7 illustrates another exemplary Compare webpage that may be displayed to an individual seeking to make a health care decision regarding a selected health care issue, in accordance with an embodiment of the present invention;

FIG. 8 illustrates an exemplary Learn webpage 800 that may be displayed to an individual seeking to make a health care decision regarding a selected health care issue, in accordance with an embodiment of the present invention;

FIG. 9 illustrates an exemplary Connect webpage that may be displayed to an individual seeking to make a health care decision regarding a selected health care issue, in accordance with an embodiment of the present invention;

FIG. 10 illustrates an exemplary Take Action webpage that may be displayed to an individual seeking to make a health care decision regarding the selected health care issue, in accordance with an embodiment of the present invention;

FIG. 11 illustrates an exemplary entity-relationship diagram for storing survey information, in accordance with an embodiment of the invention; and

FIG. 12 illustrates a simplified diagram of an exemplary server, in accordance with an embodiment of the present invention.

### DETAILED DESCRIPTION

Decision-making regarding health issues is hard and people have their own ways of making a decision. However, regardless of personal preferences and demographic variation, people consistently follow a simple process. There are four common touch points to any health decision: LEARNING about the health issue they are facing, COMPARING medical care options and their effectiveness, usage/popularity, and/or availability, CONNECTING with others that have experienced similar health issue, and DECIDING in the context of out-of-pocket cost, convenience to access, impact on work and user's personal life and/or plan coverage.

People typically hit these four touch points as they make a health decision. While the specifics will vary from person to person—for example, how much time, the order and how deep they go into any one or more of these touch points will vary considerably and will be influenced by personal preferences and situations, the touch points remain the same. Further, a person's sense of confidence in a health decision they make is typically influenced by whether they hit the four touch points or not. Furthermore, people who hit the four touch points are more likely to state that they feel informed about their health situation, more confident in their ability to take action, more vested in their decisions and sustain behavior longer than those who do not.

An embodiment of the present invention, provides a support platform that incorporates these behavioral and other findings and helps users efficiently hit the touch points. This platform may focus on the whole person and support the natural decision process while helping the user optimize their choices by considering cost, insurance coverage and access constraints. By doing so, this platform may help reduce the time spent, and the number of calls, emails and inquiries people make in attempting to make a health care decision. This platform may thus help users make better and cost-efficient decisions and take effective action, while increasing the users' comfort level with their choices. This may save both the employee and employer time and money.

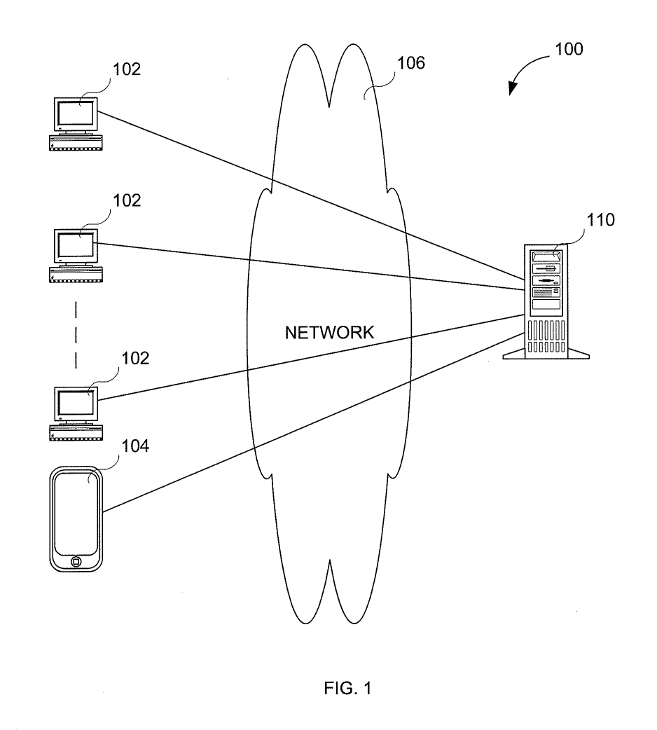

FIG. 1 illustrates an exemplary system 100 by which a user may access information for making a decision regarding a treatment option for a health care issue, in accordance with an embodiment of the invention. As illustrated, the system 100 may comprise a server 110 that may be configured, for example, for supporting one or more web pages. Server 110 is connected to a network 106 that may comprise, for example, one or more of the Internet, a Wide Area Network (WAN), a local area network (LAN), a wireless (e.g., cellular) network, etc. Server 110 may comprises a network interface (not shown) for connecting to network 106 and transmitting/receiving information via network 106. Server 110 may further comprise a storage (not shown) containing software and data for generating web pages such as described below. Server 110 may further comprise a processor configured to generate the web pages and transfer the web pages to the user via the network interface (not shown)

A consumer may access server 110 using, for example, a computer (e.g., a personal, business, or tablet computer) 102, a smart phone 104, etc. Computer 102 and smart phone 104 may execute software (e.g., a browser) that enables connection with server 104. Although the below description will be discussed with reference to an individual accessing server 110 using a computer 102 via a browser application, it should be understood that in other embodiments, the user may access server 110 using a smart phone 104 or any other suitable type of device (e.g., an Ipad). In such instances, the smart phone 104 or other device may execute a browser program or a specific application (e.g., a mobile application built specifically for accessing server 110 and performing functions, such as those discussed below). Such applications may permit the user to select links, icons, or areas using, for example, the touch of their fingers or any other suitable mechanism.

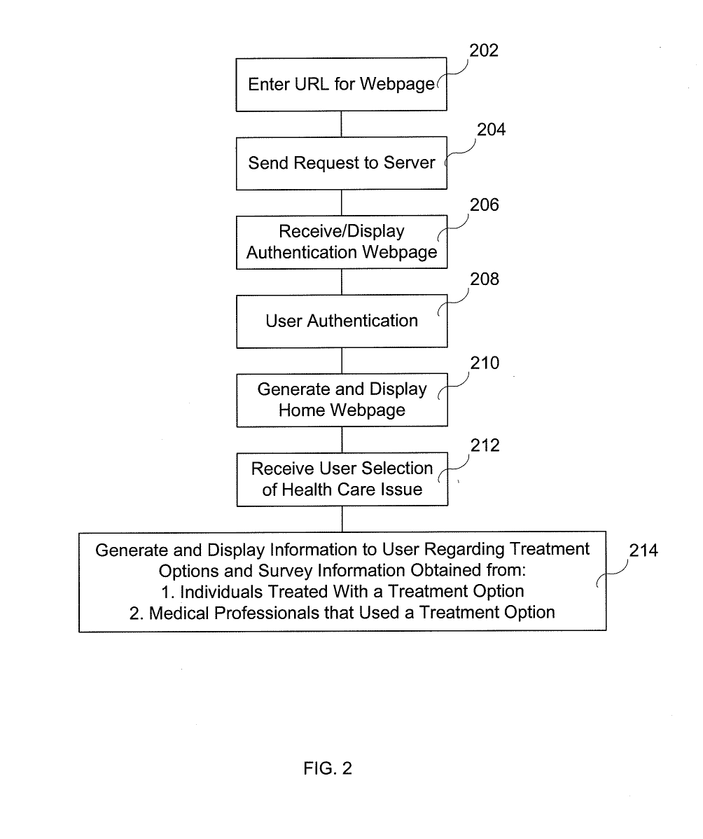

FIG. 2 provides a flow chart of an exemplary method for providing health care information to an individual, in accordance with an embodiment of the present invention. FIG. 2 will be discussed with reference to the above-discussed FIG. 1. For ease of explanation, the following description will be discussed with reference to an individual accessing server 110 via a computer 102. However, it should be understood that similar principles may apply if the individual accesses server 110 via other mechanisms (e.g., using smart phone 104).

An individual seeking to make a decision regarding a health care issue may execute software (e.g., browser software) on the computer 102 and enter a uniform resource locator (URL) indicating that they wish to view a webpage from server 110, at step 202. In response, computer 102 sends a request to server 110 for the webpage corresponding to the URL at step 204. In the presently discussed embodiment, the URL may identify a webpage that an individual may access to obtain information and make a decision about how to treat a health care issue with regard to a health care topic, which in this example is pregnancy. However, in other embodiment, the URL may identify a webpage for other types of health care topics, such as musculoskeletal and arthritis issues, cardiac health and hypertension issues, mental issues (e.g., stress, depression, etc.) diabetes, respiratory issues, etc.

Server 110, at step 206, receives the request for the webpage and sends the webpage to the computer 102. The browser software on the computer 102 then displays the webpage to the individual at step 208.

This initial webpage may be an authentication webpage that requests the individual to enter their user name and password, or if they do not have a user name and password to register for a user name and password. The server 110 may then check the user name and password against stored user name and password combinations. If the username and password correspond to a stored user name/password combination, then the server 110 deems the individual authenticated. Because the user may interact with server 110 using this initial webpage, the webpage is also referred to as a user interface, herein.

In an embodiment, server 110 may store information for a plurality of different companies and their health insurance plans. Server 110 may further store information associating a particular user name with a particular company and/or health care plan. For example, after authenticating a user, server 110 may lookup stored information regarding the user, such as the company they work for (or otherwise are associated with) and/or the user's health plan. The server 110 may then use this information in generating subsequent pages (i.e., user interfaces) displayed to the individual.

In another embodiment, the authentication step may involve other mechanisms for identifying a health service plan or company with the individual. Or, for example, the server 110 may not require that the individual be authenticated. For example, in an embodiment, anyone may be able to publicly access server 110 to obtain information such as discussed below without entering user name and/or password information. In such an example, the server 110 may allow the individual to select their health care plan (e.g., using a pull down list that may provide Medicare and Medicaid as exemplary options that the individual may select.)

After authenticating the individual, server 110 may at step 210 obtain information corresponding to the authentication information (e.g., what health care plans are available to the individual), generate, using this information, a webpage that permits the individual to identify their health care issue and then transfer the generated webpage to computer 102. In another embodiment, rather than the user going to a webpage associated with a particular health care topic (e.g., pregnancy, musculoskeletal, etc.) and then providing authentication information, the user may first go to a general webpage (e.g., a webpage provided by the company they work for, a webpage provided by a health insurance carrier, etc.) and then enter authentication information. After which, the server 110 may generate a webpage that allows the user to select the particular health care topic (e.g., pregnancy, musculoskeletal) they are interested in, and then, in response server 110 generates a webpage the permits the individual to identify their health care issue. As noted above, in the presently discussed embodiment, the individual is seeking to make a decision regarding how to treat a health care issue pertaining to pregnancy.

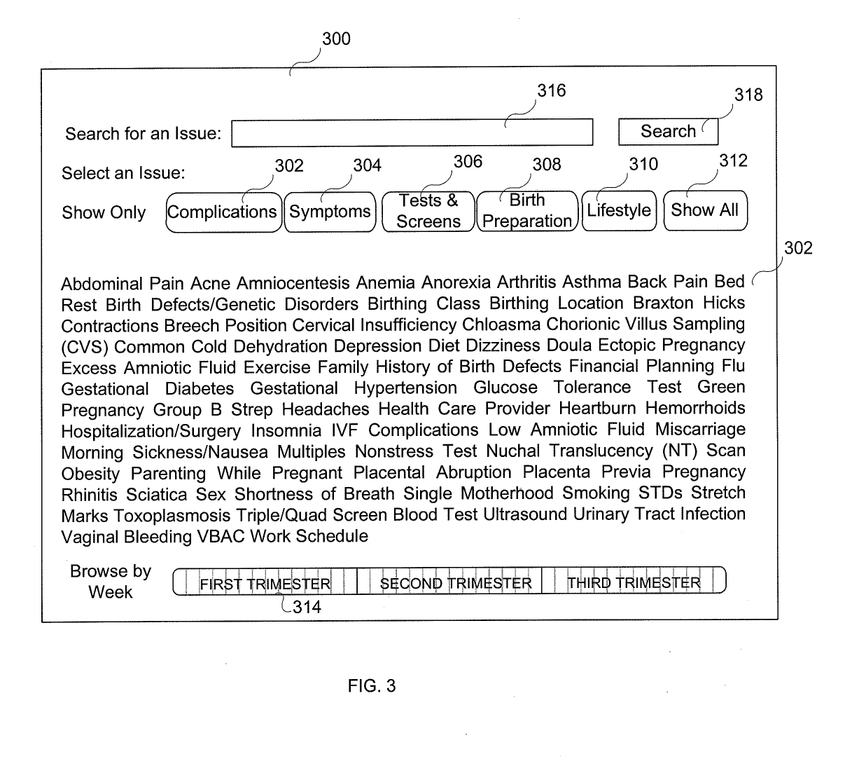

FIG. 3 illustrates an exemplary webpage 300 that an individual may use to select a particular health care issue associated with a particular health care topic (e.g., pregnancy). Because webpage 300 permits the user to interact with a device (i.e., server 110), webpage 300 is also referred to as a user interface herein.

Webpage 300 may be generated by server 110, as noted above, based on information stored by server 110, such as information regarding one or more health care plans available to the individual based on the stored information associating the individual (via their authentication information) with one or more health care plans.

As illustrated, webpage 300 includes a listing 302 of possible health care issues relating to pregnancy that a user may select by, for example, directing the pointer for a mouse over a particular issue and left clicking on the issue to take the individual to a webpage regarding this issue. A further description of exemplary webpages that server 110 may generate and provide to a user for a particular issue is presented below.

In addition to listing 302, the webpage 300 comprises a plurality of buttons: Complications 304, Symptoms 306, Tests & Screens 308, Birth Preparation 310, and Lifestyle 312 that the individual may select using a mouse. Selection of one of these buttons 304-312 will cause those health care issues corresponding to the selected button to be highlighted (and the other issues deemphasized). For example, those issues corresponding to a particular issue may have their font size increased and their color displayed in a uniform color, while the other issues (i.e., those not corresponding to the selected button) have their font size decreased and their color changed to a muted color. For example, if the individual selects the Complications button 302, the following health care issues in listing 302 may be highlighted: Birth Defects/Genetic Disorders; Breech Position; Cervical Insufficiency; Common Cold; Ectopic Pregnancy; Excess Amniotic Fluid; Family History of Birth Defects; Flu; Gestational Diabetes; Gestational Hypertension; Group B Strep IVF Complications; Low Amniotic Fluid; Miscarriage; Multiples; Obesity; Placental Abruption; Placenta Previa; STDs; Toxoplasmosis; and VBAC.

Webpage 300 also includes a show all button 312 that may return the listing 302 to its original settings (e.g., where each of the health care issues are displayed using a uniform font and color).

In addition to listing 302, webpage 300 may comprise a series of buttons 314 related to different weeks of pregnancy. These buttons 314 may be side-by-side and organized by the first trimester, the second trimester, and the third trimester. If a user selects one of the buttons 314, the health care issues in listing 312 that often occur during the selected week of pregnancy are highlighted (e.g., using a different font, color, etc.).

Webpage may also have a box 316 in which the individual may enter characters and/or numbers to enable the individual to search for a particular issue. Once a user enters information in box 316, the individual may select a search button 318. In response, server 110 may search stored information (e.g., web pages) in server 110 for information matching the entered information and then display a webpage with a listing of web pages corresponding to the searched information. Search functionality provided by a webpage is well known to those of skill in the art and as such, is not discussed further herein.

The individual then selects a particular health issue from the listing at step 212. This selection is then communicated to the server 110 that, in response, sends a webpage corresponding to the selected issue to the individual's computer 102 at step 214.

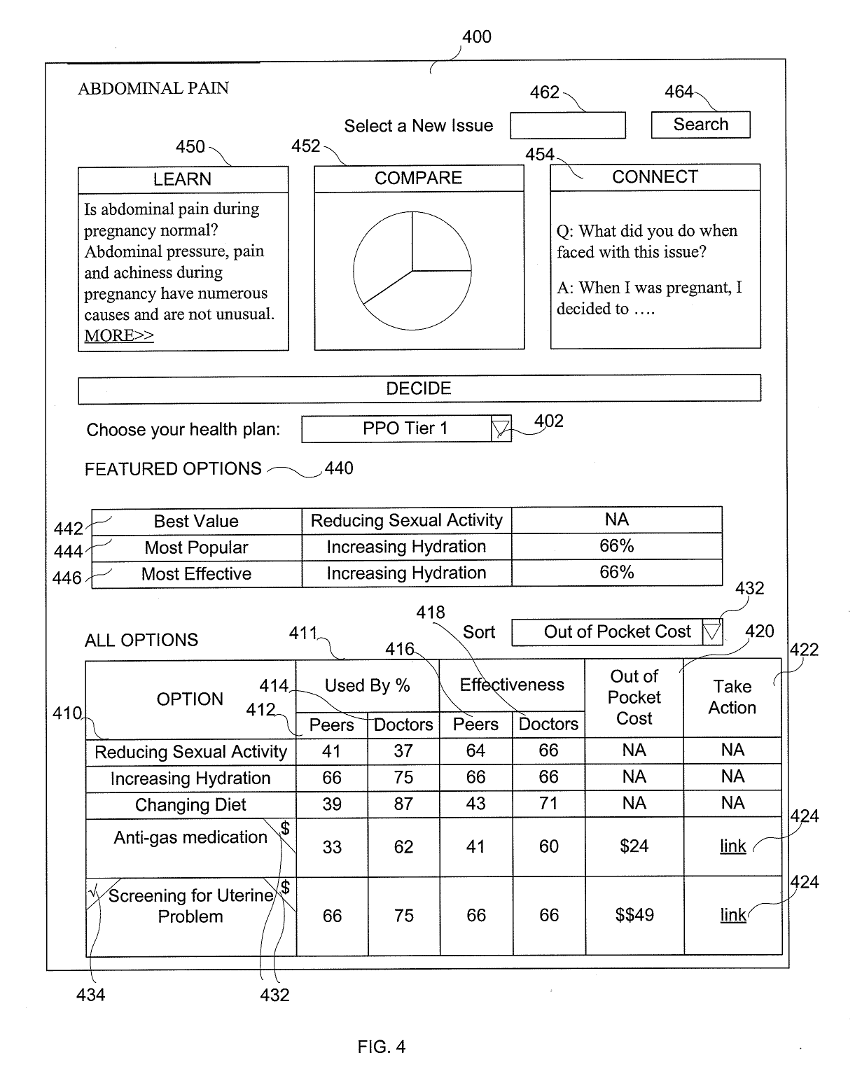

FIG. 4 illustrates an exemplary webpage 400 that may be displayed to an individual seeking to make a health care decision regarding the selected health care issue, in accordance with an embodiment of the present invention. This webpage 400, as well as the other web pages discussed below, may be generated by server 110 and sent to computer 102, which displays the generated webpage. In the illustrated embodiment, it is assumed that the individual selected the Abdominal Pain health care issue included in listing 312 of webpage 300 (FIG. 3). The illustrated webpage of FIG. 4 will be referred to herein as the Decide webpage 400.

As illustrated, the Decide webpage 400 comprises a pull down 402 that an individual may use to select their health plan. For example, as noted above, in an embodiment, server 110 may store information associating individuals (via, their authentication information, such as their user name) with a particular company. Server 110 may further store information regarding the health care plans provided to employees of the company. In such an example, pull down 402 may include the various health plans provided by the company, so that the individual may select their particular health plan. In an other embodiment, server 110 may also store information directly associating the individual (e.g., via their user name) with the health care plan that the individual subscribes to. In which case, the pull down 402 may not be included, and instead replaced with text identifying the health care plan associated with the individual. Or, for example, in an embodiment in which the individual is not authenticated, the pull down 402 may include health plans that the individual may select (such as, Medicare and Medicaid).

Decide webpage 400 may also list various treatment options available for treating the selected health care issue (e.g., abdominal pain). The various listed treatment options may be options identified by, for example, a panel of medical professionals (e.g., doctors) as possible acceptable treatment options for the health care issue.

As illustrated, each of the available options may presented on the Decide webpage 400 in a list along with information regarding the treatment option obtained by a survey of individuals and/or doctors. For example, in the illustrated embodiment, Decide webpage 400 comprises a list 410 of treatment options along with comparison information regarding the health care information gathered from a plurality of individuals that used at least one of the plurality of treatment options in treating the health care issue. As used herein, the term comparison information refers to information that enables an individual to make a comparison.

As illustrated, Decide webpage 400 includes a table 411 listing each treatment option, along with a percentage of individuals 412 and medical professionals (e.g., doctors) 414 that used the treatment option. The table also includes information regarding the percentage of individuals 416 and doctors 418 that found the treatment to be effective for themselves.

In an embodiment, this comparison information may be stored by server 110. For example, server 110 may store information regarding a statistical survey provided to a statistically significant number of individuals that were affected by a health care issue relating to the health care topic. For example, a survey may be provided to individuals who sought care from a doctor during their pregnancy. This survey may ask the individuals a plurality of questions, such as, whether or not they affected by the health care issue (e.g., did the experience abdominal pain during their pregnancy); and, if so, which if any, of the treatment options they used. The survey may further ask, for each treatment option they used, whether they found the treatment option to be effective.

A similar survey may be provided to medical professionals (e.g., doctors) who faced the same medical issue for themselves. This survey may ask the medical professionals (e.g., doctors) questions regarding their personal experience with health care issue(s) regarding the health care topic (e.g., pregnancy) as well as what treatment option(s) they personally used.

In another embodiment, a survey may be provided to medical professionals (e.g., doctors) that treated an individual affected with a health care issue pertaining to the health care matter (e.g., pregnancy). This survey may ask the medical professionals questions regarding their treatment of the individuals affected by the health care issue(s).

The results of these survey (e.g., the survey provided to the individuals and the survey provided to the doctors) may be stored by server 110. A further description of how server 110 may store this information and use this information for generating web pages, such as those discussed herein is presented below. As used herein, the term “medical professional” refers to individuals whose profession involves treating health care issues, such as medical doctors, nurses, etc.

As illustrated, Decision webpage 400 provides, in the table 411, for each of the listed treatment options 410, the results of the survey provided to the individuals affected with the health care issue for two survey questions: what percentage used the treatment option 412 and what percentage found the treatment option to be effective 416. Similarly, the Decision webpage 400 also includes in the table 411, for of the listed treatment options 410, the results of the survey provided to the doctors who personally faced the medical issue themselves and what actions they took personally: what percentage used the treatment option in treating the individual 414 and what percentage found the treatment option to be effective 418. Further, in an embodiment, Decision webpage 400 may include the results of the survey provided to doctors that treated an individual impacted by a health care issue related to the topic in addition to, or, for example, in lieu of one or more of the survey results provided on the illustrated Decision webpage 400.

In addition to table 411 including the results of particular survey questions, table 411 may also include additional information. For example, as illustrated, table 411 includes a column identifying the out of pocket costs 420 to the individual for each treatment option. This information may be stored in or calculated by server 110 and vary according to the individual's health care plan (e.g., the plan selected using pull down 402 or the health care plan that server 110 otherwise associates with the individual).

Table 411 may further include a take action column 422 that may include links 424 that the individual may click on to go to a webpage that allows the individual to take an action associated with the corresponding treatment option. For example, table 411 may include a link 424 that the individual may click on for the anti-gas medication treatment option to go to a webpage that may permit the individual to order anti-gas medication or find company or health plan carrier provided resources as well as price or health premium discounts and any related incentives offered. A further description of an exemplary take action webpage that server 110 may generate and display to the individual is discussed in further detail below.

Table 411 may further include one or more symbols for each of the listed treatment options. For example, table 411 may include a qualified expense symbol 432 that identifies the treatment option as a treatment option that the individual may be able to obtain at least partial reimbursement for through their health care plan.

Table 411 may also include a coverage symbol 434 identifying the treatment option as an option that is covered by their health care plan, such as, for example, treatment options for which the individual may only have to pay a co-pay for if they see a medical professional, such as a medical professional in a medical network associated with the health care plan.

Each of these symbols 432 and 434 may have popup description boxes (not shown) that may popup when the individual places the mouse pointer on the symbol. These description boxes may include further information regarding the individual's health care coverage associated with the treatment option. For example, the popup description box for the qualified expense symbol 432 may include information indicating whether the treatment option only qualifies as a qualified expense if the treatment option is prescribed by a doctor. And, for example, the popup description box for the coverage symbol may include information such as the co-pay amount if the individual seeks treatment from an in-network medical professional and/or the reimbursement percentage should the individual seek treatment from an out-of-network medical professional.

Decision webpage 400 may also include a pull down 432 that lists one or more or all of the titles for the columns included in table 411 to enable the table to be sorted according to the title selected in pull down 432.

Decision webpage 400 may also include a featured section 440 that features one or more of the treatment options from list 410. In the illustrated example, the featured section 440 includes a table that identifies the treatment option that is the best value 442, the treatment option that is most popular 446, and the treatment option that is the most effective 448. The treatment options corresponding to these categories (442-448) may be selected based on the corresponding information included in table 411.

Decision webpage 400 may also include a search box 462 and search button 464. This box 462 and button 464 may function in a similar manner to box 316 and button 318 of webpage 300 (FIG. 3).

Decision webpage 400 may also include buttons or regions that the individual may click on to take them to other web pages. It may also provide the ability for the user to purchase or fulfill a product or service. In the illustrated example, the Design webpage 400 includes a region 450 that the individual can click on to go to a Learn webpage, a region 452 that the individual can click on to go to a Compare webpage, and a region 454 that the individual can click on to go to a Connect webpage. Each of these web pages are discussed in further detail below. Further, as noted above, server 110 may generate these web pages using information stored in server 110. A further description of how server 110 may store such information and relate the stored information for generating web pages, such as webpage 400 is presented below.

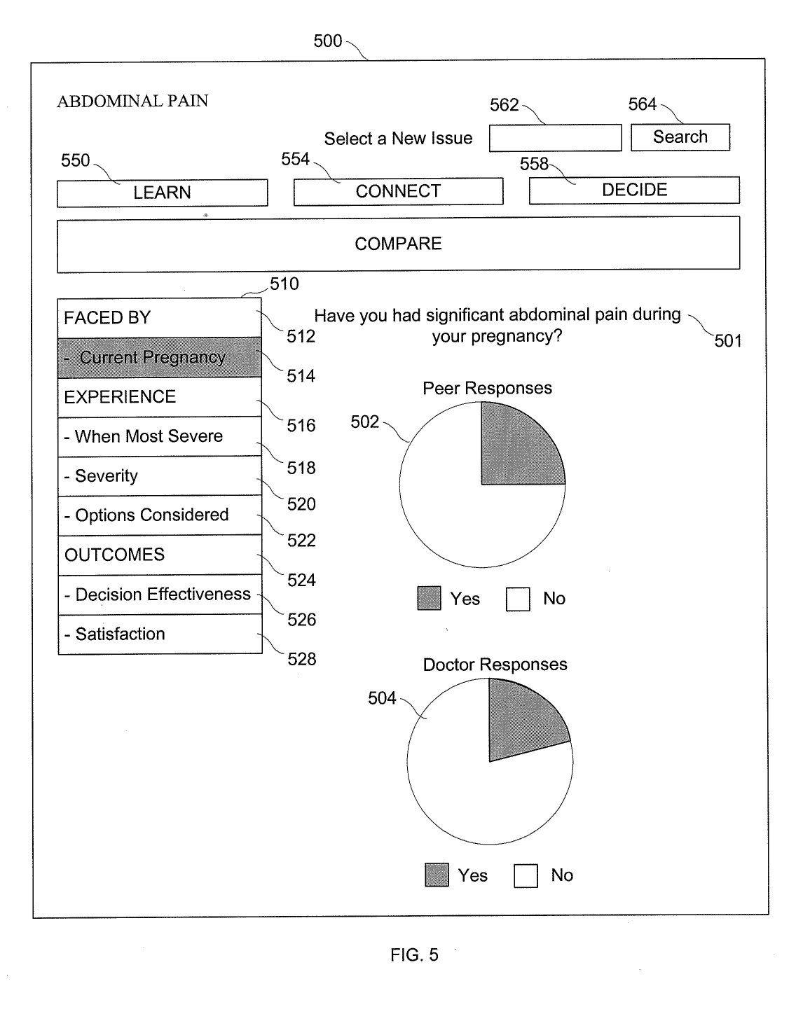

FIG. 5 illustrates an exemplary Compare webpage 500 that may be displayed to an individual seeking to make a health care decision regarding the selected health care issue, in accordance with an embodiment of the present invention. The Compare webpage 500 may provide comparison information to the individual to enable the individual to compare the various treatment options. This comparison information may stored by server 110 and obtained using, for example, a statistical survey of individuals and doctors who were affected by a health care issue relating to the health care topic (e.g., pregnancy), such as discussed above.

As illustrated, Compare webpage 500 includes the survey question 501, which in this case is “Have you had significant abdominal pain during your pregnancy?” In addition, webpage 500 includes a peer response pie chart 502 that identifies the percentage of individuals who answered yes to this question in response to the survey provided to individuals that sought medical care during their pregnancy. Webpage 500 further includes a doctor response pie chart 504 that identifies the percentage of doctors that answered yes to this question in response to the survey provided to doctors that faced the particular issue when they were pregnant themselves. An individual experiencing abdominal pain during their pregnancy can view this comparison information to see how frequent their condition is. Further, providing both the individual's response and doctor's response on the same page enables the individual to readily compare the responses from their peers and the doctors.

In addition, to this exemplary survey question, the Compare webpage 500 may also be used to view other comparison information. In the illustrated embodiment, webpage 500 comprises a listing of links 510 to additional comparison information. These links may be organized by categories. For example, in the exemplary illustration, the list includes the categories: Faced by 512; Experience 516; and Outcomes 524. Under the Faced By category 510 is a link entitled “Current Pregnancy” 514. This link 514 is highlighted in gray to indicate that it is the link to the current page.

Under the Experience 516 category are four links: “When most severe” 518, “Severity” 518, and “Options Considered” 522. These links are directed to web pages including comparison information regarding the individual's experience when affected by the health care issue. Under the Outcomes 524 category are two links: “Decision Effectiveness” 526 and “Satisfaction” 528. These links are directed to web pages including comparison information regarding the outcome in response to the various treatment options.

Compare webpage 500 may also include a region 550 that the individual can click on to go to the Learn webpage, a region 554 that the individual can click on to go to the Connect webpage, and a region 558 that the individual can click on to go to the Decision webpage 400. Webpage may also include a box 562 and a search 564 button that may function as discussed above with regard to the similarly named items of FIG. 3

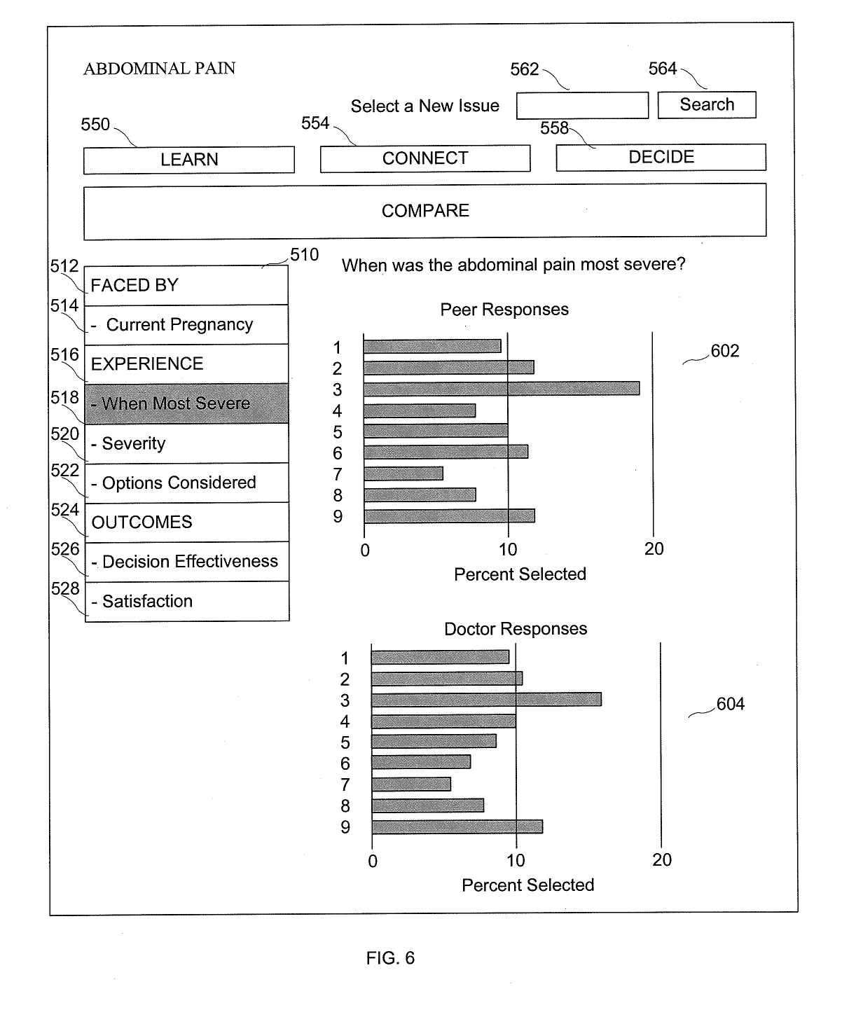

FIG. 6 illustrates an exemplary Compare webpage 600 that may be displayed to an individual seeking to make a health care decision regarding the selected health care issue, in accordance with an embodiment of the present invention. In this example, the individual has selected the “When Most Severe” link 518 from the list 510.

In this example, the surveyed individuals and doctors were asked to identify the month of their pregnancy during which the abdominal pain was most severe. As illustrated, Compare webpage 600 includes a bar chart 602 indicating for each month the percentage of individuals that identified the month as the month during which the pain was most severe. Compare webpage 600 also includes a bar chart 604 including the Doctor's response to this survey question.

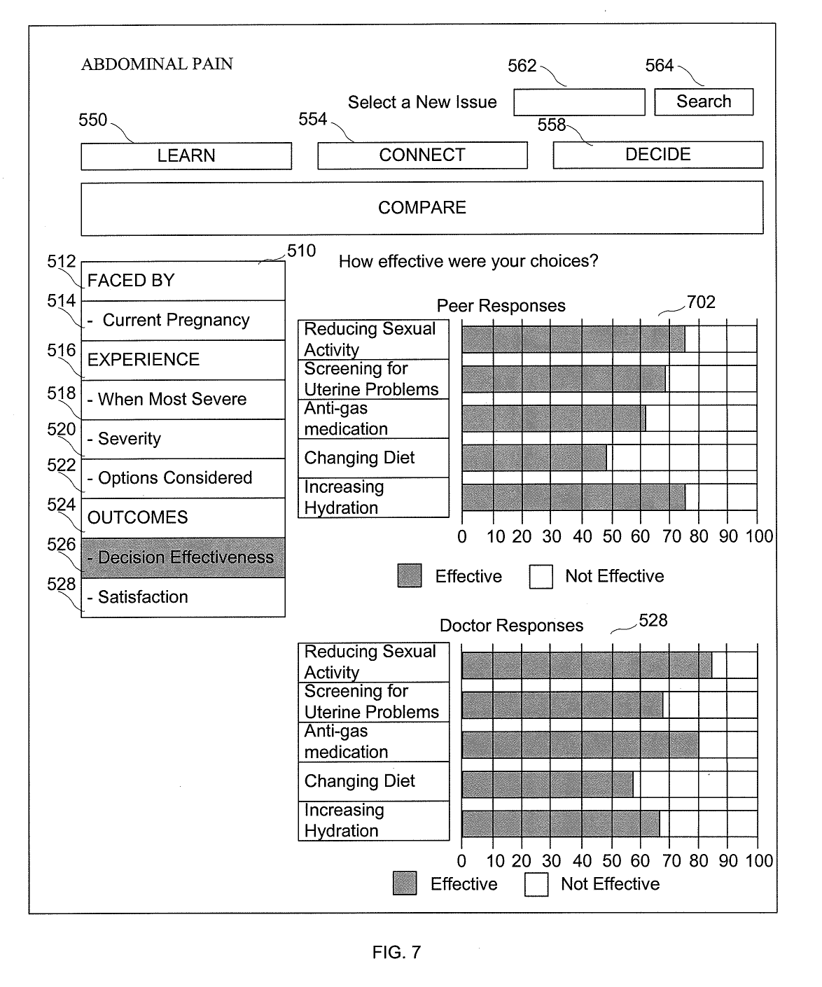

FIG. 7 illustrates an exemplary Compare webpage 700 that may be displayed to an individual seeking to make a health care decision regarding the selected health care issue, in accordance with an embodiment of the present invention. In this example, the individual has selected the “Decision Effectiveness” link 526 from the list 510.

In this example, the individuals were asked, for each treatment option they used, was the treatment option effective. The doctors were similarly asked this question. Compare webpage 700 includes a bar chart 702 indicating, for each treatment option, the percentage of individuals that found the treatment option to be effective.

With regard to the other types of exemplary comparison information available through the Compare web pages 500, 600, and 700, a Compare webpage may be presented that include survey information regarding the “Severity” 520 of the abdominal pain. The comparison information presented for the “Severity” may include the percentage of individuals that experience abdominal pain that found the pain not severe, somewhat severe, severe, and very severe. This information may be presented using a bar chart such as illustrated in Compare webpage 700.

The comparison information presented on a Compare webpage under, for example, the Experience 516 category may also include survey information indicating for each treatment option whether the treatment option was considered, and if so, whether it was used (“Options Considered” 522). This information may be obtained via the survey presented to the individuals and the survey presented to the doctors. This information may, for example be presented using bar charts, similar to the bar charts used in Compare webpage 700.

The comparison information presented on a Compare webpage may also include survey information regarding the “Advice Sought” in the Experience 516 category. This comparison information may include survey information from individuals who experienced abdominal pain on whether or not they sought medical advice from a doctor regarding their abdominal pain. The information may, for example, be presented using a pie chart indicating the percentage of individual who sought medical advice. Similarly, the Advice Sought information presented on Compare webpage may include the survey results obtained from doctors. It should be noted that in the above-description, survey information is presented on the Compare webpage(s) for information obtained from both individuals and doctors. In other embodiments, the Compare webpage may include survey information from only one of individuals and doctors. Or, for example, some information may be presented using survey results from both individuals and doctors while other survey results are presented using survey results from either individual or doctors, but not both. The particularities of how the information is presented may depend, for example, in part on the specifics of the survey question.

The comparison information presented on a Compare webpage may also include survey information regarding how satisfied (“Satisfaction” 528) the individual was with how they managed the abdominal pain.

It should be understood that the above discussed Compare webpages are but one example of comparison information that may be presented using Compare webpages, and in other embodiments other types of comparison information may be presented. Further, the particular information presented may vary according to the type of health care matter and/or health care issue for which the is seeking to make a decision regarding treatment. For example, for musculoskeletal health care issues, different types of comparison information may be presented. Thus, the particular information presented may be tailored to the particular health care matter (e.g., pregnancy, musculoskeletal) and health care issue (e.g., abdominal pain, acne, Amnicenteses, Ankle Pain, Back/Neck Sciatica, Hip Sciatica, etc.)

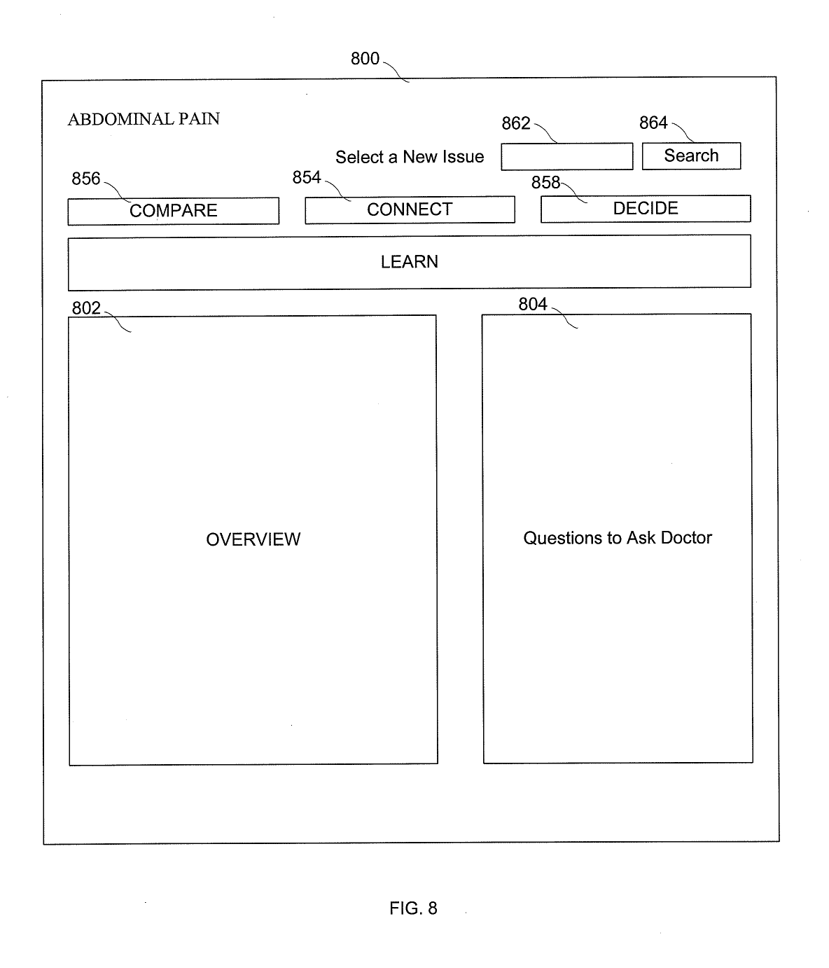

As noted above, each of the Compare and Decide webpages may include an area (e.g., a tab) 450 and 550, that the individual can click on to go to a Learn webpage as well as learn about their company provided resources or incentives/discounts. FIG. 8 illustrates an exemplary Learn webpage 800 that may be displayed to an individual seeking to make a health care decision regarding the selected health care issue, in accordance with an embodiment of the present invention. The Learn webpage 800 may be provided to the individual so that they can obtain additional information regarding the selected health care issue (e.g., abdominal pain). As illustrated, Learn webpage 800 may include a section for providing an overview section 802 that provides a general overview of the health care issue. The information presented in the overview section 802 may include specifically tailored information regarding the health care issue that an individual seeking treatment regarding the health care issue is likely to want to know. This information may include, for example, whether the health care issue is normal, what causes it, and what they should do if they experience the health care issue.

Learn webpage 800 may also include a questions section 804 that includes a list of questions they should ask their doctor when seeking treatment for the health care issue. These questions may be determined by, for example, a panel of doctors and/or other medical professionals.

Learn webpage 800 may also include areas (e.g., tabs) that an individual may seek to go to a Compare webpage, the Connect webpage, and the Decide webpage (e.g., tabs 856, 854, and 858, respectively). Further, the Learn webpage may include a box 862 and search button 864 for conducting a search, such as discussed above.

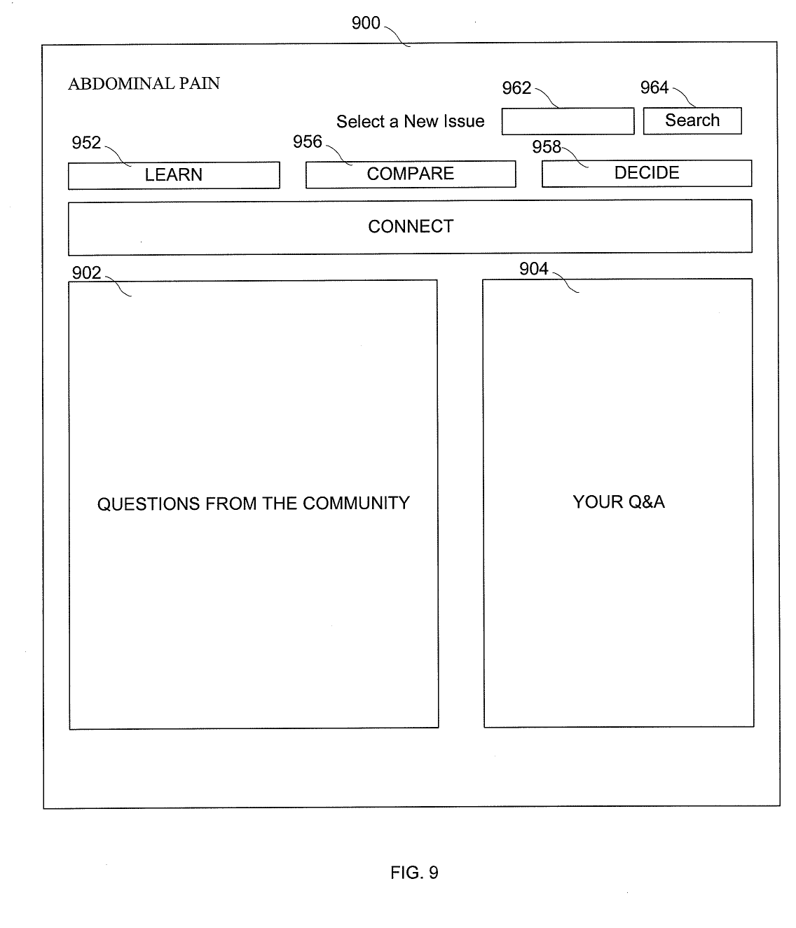

FIG. 9 illustrates an exemplary Connect webpage 900 that may be displayed to an individual seeking to make a health care decision regarding the selected health care issue, in accordance with an embodiment of the present invention. The Connect webpage 900 may enable the individual to connect with other individuals affected by the health care issue.

As illustrated, Connect webpage 900 may include a Questions from the Community section 902. This section 902 may be implemented as a message board that allows individuals to post questions and respond to other peoples questions. Section 902 may be implemented using standard message board technology. The questions and answers posted in section 902 may be anonymous and include no identifying information regarding the individual so as to protect the individual's privacy. Further, in an embodiment, an individual may be able to select a message board name for use in posting questions and responses in section 902. This message board name may be a unique name associated with the individual (i.e., it is tied to their username and password). Further, this message board name may allow the individual to select a name that is personally identifiable (e.g., it is their legal name or nickname) with them or protects their anonymity (e.g., the message board name is a fantasy name—e.g., PGMOM2). Further, in embodiments in which the individual may select a message board name, section 902 may further include an option that enables the individual to post a question or response as “Anonymous” or a similar type of designation used to protect the individual's identity. Although not illustrated in Connect webpage 900, section 902 may include various buttons, links or other items that the individual may select to post a message, register a message board name, etc.

Connect webpage 900 may also include a Question and Answer section 904 to allow the individual to ask a question from a medical expert. Section 904 may, for example, include a button that when selected by the individual brings up a text box for the individual to ask a question. The individual may then, for example, select a submit button. Server 110 (FIG. 1), in response to the question being submitted, may generate an e-mail to an address associated with the health care issue that includes the question entered by the individual. Server 110 (FIG. 1) may then send this e-mail to the corresponding address where a medical expert (e.g., a doctor) can answer the question. Server 110 (FIG. 1) may further modify section 904 so that it includes the question asked. Section 904 may be an individualized section, so that the information presented in section 904 is unique to the individual (i.e., the user name entered during the above-discussed authentication step of FIG. 2).

The medical expert answering the question may then reply to the e-mail with an answer or a follow-up question. When server 110 (FIG. 1) receives the reply e-mail, server 110 (FIG. 1) may modify Connect webpage 900 so that the answer in the reply e-mail is included in section 904 (e.g., below the question asked by the individual). As noted above, section 904 may be unique to the individual so that only a person signing in with the individual's user name and password will include this question and answer in section 904.

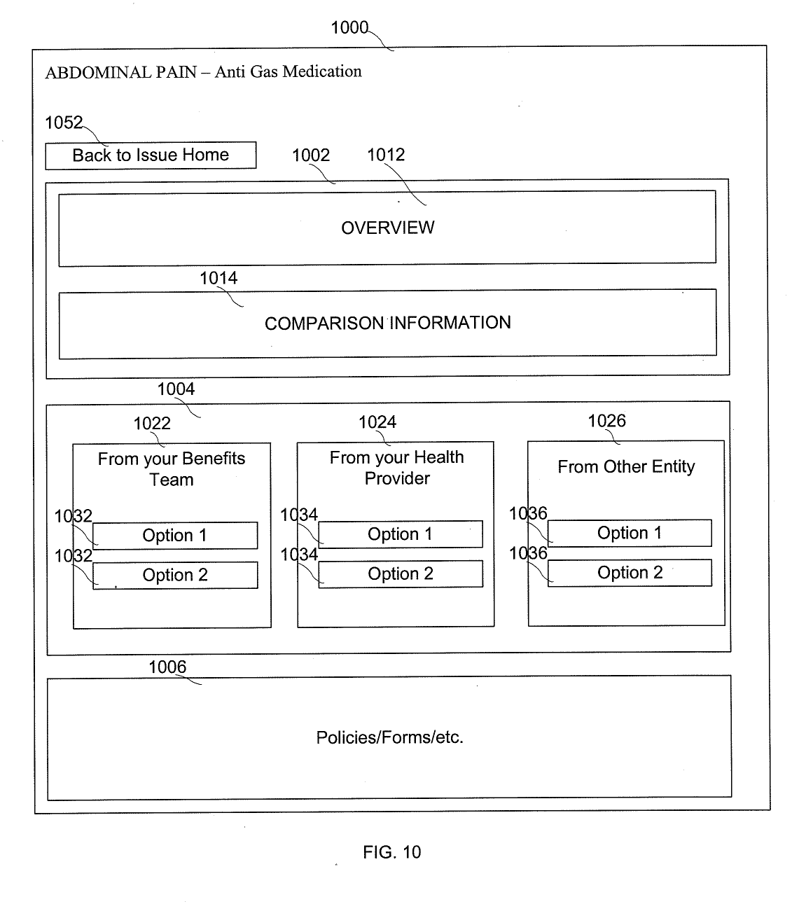

As noted above, Decide webpage 400 (FIG. 4) may include a link 424 that an individual may click on to take an action associated with a particular treatment option. FIG. 10 illustrates an exemplary Take Action webpage 1000 that may be displayed to an individual seeking to make a health care decision regarding the selected health care issue, in accordance with an embodiment of the present invention.

Take Action webpage 1000 may include a general information section 1002 that includes general information regarding the treatment option. For example, general information 1002 may include an overview section 1012 and a comparison information 1014 section. Overview section 1012 may include text providing additional information regarding the treatment option. For example, for the anti-gas medication treatment option, the overview section 1012 may include information identifying the name of the medication (e.g., both the generic drug name and brand name(s)) for the medication. It may further identify whether the medication is available over the counter or by prescription only. It may also include information identifying precautions regarding the medication, such as whether the medication is addictive and possible side effects of the medication. The overview section 1012 may further include information identifying the type of medical professional (obstetrician, chiropractor) that the individual should contact regarding the treatment option, an overview of the type of medical professional (e.g., information such as “a chiropractor is trained on treating musculoskeletal and neurological problems without drugs or surgery.”), as well as precautions the individual may wish to take (e.g., “only work with a board-certified or state-licensed chiropractor”).

Comparison section 1014 may include information that enables the individual to compare the treatment option with the other treatment options. For example, comparison section 1014 may include the information in table 411 (FIG. 4) of the treatment option so that the individual has the information readily available to the individual without having to return to the previous webpage (e.g., Decide webpage 400).

Take Action webpage 1000 may also include an action section 1004 that may include information and/or links for one or more actions that the individual may take. Action section 1004 may be organized such that it includes a benefits team section 1022, a health provider section 1024 and an other entity section 1026.

Benefits team section 1022 may include information and/or links regarding option(s) 1032 that are available through, for example, their company. For example, the individual's company may provide a health care help line that employees may call to speak to an individual to obtain information regarding the individual's health care plan. In such, an example, the option 1032 information provided may include a general description of this option as well as the phone number. Option(s) 1032 may also include, for example, information regarding how the individual may obtain other types of information, such as, that the company provides an employee assistance program that the individual may contact to obtain assessment, counseling and/or referrals through the company as well as information regarding how the individual may obtain this assistance (e.g., a phone number or link to a webpage associated with the assistance program).

Health provider section 1022 may include information and/or links regarding option(s) 1034 available through the health care plan to which the individual subscribes. This information may include, for example, information (e.g., a phone number or link) that the individual may use to contact a 24-hour medical advice line where the individual may be able to communicate with (e.g., speak to) a medical profession (e.g., a registered nurse) regarding the treatment option. Or, for example, this information may include information (e.g., a phone number or link) that the individual may use to make an appointment with a medical professional regarding the treatment option.

Other entity section 1024 may include information and/or links regarding option(s) 1036 available through other entities. For example, option(s) may include a link to a webpage through which the individual may purchase medication (e.g., for treatment options using over-the-counter medications) or other product (e.g., band-aids, crutches, etc.), such as, for example, an on-line retailer or a local pharmacy that sells the product (e.g., medication) associated with the treatment option. Or, for example, option(s) may include links that a user may click on to go to, for example, a Connect webpage, such as discussed above, or a link that enables the individual to communicate with a medical professional such as discussed above with reference to Connect webpage 800.

As noted above, the information provided to the individual to help the individual to make a decision regarding treatment of a particular health care issue may be presented to the individual via web pages generated by a server. The following provides an exemplary description of a mechanism that a server may use in generating web pages, such as those discussed above with reference to FIGS. 4-10. The following description will be discussed with the above-discussed FIG. 1 for explanatory purposes.

In an embodiment server 110 may store information regarding a plurality of individuals, health care plans, entities (e.g., companies), health care topics (e.g., pregnancy, musculoskeletal, etc.) and associated health care issues (abdominal pain, hip sciatica, etc.) Further, as noted above, server 110 may store survey information associated with a particular health care topic and/or health care issue. As noted above, this information may be obtained from, for example, a scientific survey provided to individuals that experienced a health care issue associated with a particular health care topic as well as doctors that experienced the health care issue.

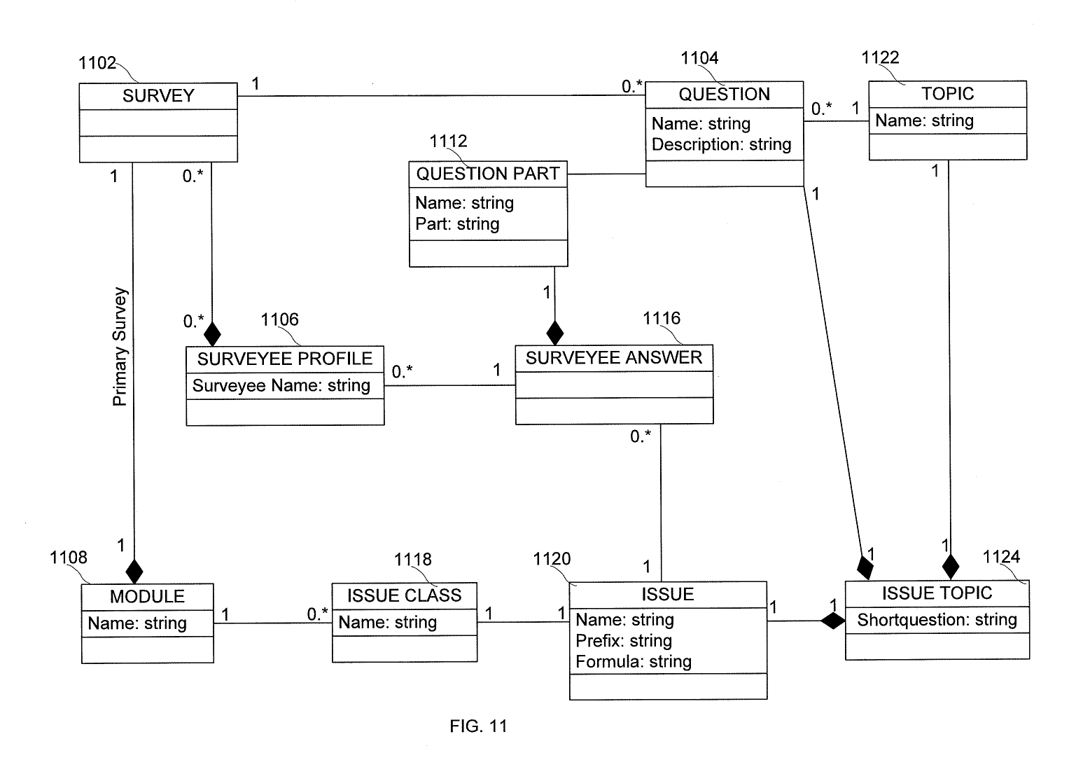

Server 110 may store one or more relational databases that server 110 may access to obtain the information presented on the above-discussed web pages. FIG. 11 illustrates an exemplary entity-relationship diagram for storing survey information, in accordance with an embodiment of the invention. A separate entity-relationship may be used for storing information regarding entities (e.g., companies), such as information relating the entity to one or more health care providers (e.g., Bluecross/Blueshield; Cigna, Kaiser, etc.) and/or plans (e.g., different PPO plans), one or more individuals (e.g. employees) for which the entity provides health care (e.g., employees of the entity) as well as information regarding the employee (e.g., authentication information for authenticating the individual; information regarding the particular health care plan the individual subscribes to etc.)

As illustrated, survey entity relationship diagram 1100 includes a parent entity entitled Survey 1102. This entity may comprise information identifying the various surveys stored by server 110. For example, server 110 may store survey information for a pregnancy survey provided to individuals and doctors with regard to the pregnancy health topic, such as discussed above. Server 110 may further store survey information for a musculoskeletal survey; a cardiac health and hypertension survey, a mental health survey regarding mental health issues (e.g., stress, depression, etc.), a diabetes survey, a respiratory health issues survey, etc. As noted above, each of these surveys may be a scientific survey provided to individuals that were effected by a health care issue regarding the particular topic as well as medical professionals (e.g., doctors) that were personally effected by that same health issue regarding the particular topic. The survey information stored by server 110 may comprise, for example, the survey questions, information regarding the persons who answered the survey, the answers the person provided; etc.) In the below description, the survey entity 1102 will be assumed to include information identifying a pregnancy survey. Further, as noted above, the stored survey information may also include, in an embodiment, the survey results for a scientific survey presented to medical professionals that treated an individual for a health care issue related to the health care topic.

Survey entity 1102 may be related in a one to 0 or more relationship to a question entity 1104 and in a 0 or more to 0 or more relationship with a survey profile entity 1108. Survey entity 1102 may further related in a one to one relationship with a module entity 1106.

The question entity 1104 may store questions for the surveys such that the questions for the survey are related to the particular survey to which they belong. Question entity 1104 may include a short hand name for the question (e.g., for quickly identifying the question) along with the text of the particular question asked in the survey. Question entity 1104 may be related to a Question part entity 1112 in a one to one or more relationship.

Question part entity 1112 may include the text for the various possible answers for each question in the survey along a with a short hand name for the answer. These answers may be accordingly be related to the corresponding question by the relationships.

The question entity 1104 may be related to a topic entity 1122 in a 0 or more to 1 relationship. The topic entity 1122 may identify the various categories of topics included in the survey. For example, the topic entity 1122 may include a name for identifying the various categories of survey information available, such as the categories of survey information presented via the above discussed exemplary Compare webpages (e.g., faced by 510, experience 516, outcomes 524 (FIG. 5)).

Surveyee profile entity 1106 may include information identifying a particular surveyee name that may be used to relate the surveyee (i.e., the individuals and/or doctors that answered the survey) to information regarding the surveyee, such as the surveyee's answers to the survey. This surveyee name may be further be usable to identify other information regarding the surveyee stored by server 110, such as demographic information regarding the surveyee. This surveyee name may be a name not associated with the actual name of the surveyee, but instead an internal name so as to protect the anonymity of the surveyee. Surveyee entity 1106 may be related to a surveyee answer entity 1116 in a 0 or more to 1 relationship.

Surveyee answer entity 1116 may include the surveyee's answers to the questions in the survey. The question part entity entity 1112 may also be related to the surveyee answer entity 1116 as illustrated.

The module entity 1108 may include information identifying the various health care topics (e.g., pregnancy, musculoskeletal, etc.). The module entity 1108 may be related to an issue class entity 1118 in a 1 to 0 or more relationship. The issue class entity 1118 may identify various body parts. For example, for the musculoskeletal health care topic information may be included identifying a plurality of different body parts (back, hip, etc.) for types of musculoskeletal health care issues. For the pregnancy health care topic, the issue class may not, for example, include information such as complications, symptoms, test and screens, birth preparation, and lifestyle discussed above with reference to FIG. 3

The issue class entity may be related to an issue entity 1120 in a 1 to 1 relationship that identifies the various health care issues. For example, these health care issues may include the issues identified in listing 302 (FIG. 3), a plurality of musculoskeletal health care issues, etc. This information included in issue class entity 1120 may include a name for the health care issue, a prefix for the issue, and a faced by formula for the issue. The prefix may be a shorthand mechanism for identifying the issue. The faced by formula may be, for example, information specifying or that is used to determine how the survey is to be presented (e.g., by calculating percentages and presenting the information via pie charts, bar charts, etc.) The surveyee answer entity 1116 may be related to the issue entity in a 0 or more to 1 relationship, such as illustrated.

The issue entity 1120 is related to an issue topic entity 1124 in a 1 to 1 relationship. The issue topic entity 1124 includes information identify specific sections of various specific health care issues. For example, these issues may include the various issues available via the above-discussed Compare web pages falling under the various categories of available information. For example, for the pregnancy health care topic, these specific sections may include information such as the above discussed current pregnancy 514 (FIG. 5) information, when most severe 518, severity 520, options considered 522, decision effectiveness 526, and satisfaction 528. The question entity 1104 and topic entity 1122 may each be related to the issue topic entity 1124 in a 1 to 1 relationship, as illustrated.

It should be noted, that this is but one example of how server 110 may relate the various information that allows server 110 to access the various information in generating the above-discussed web pages, and in other embodiments other mechanisms may be used for relating this information. Further, as noted above, because each of the above-discussed web pages enable the user to interact with a device (e.g., server 110), they may also referred to as user interfaces herein.

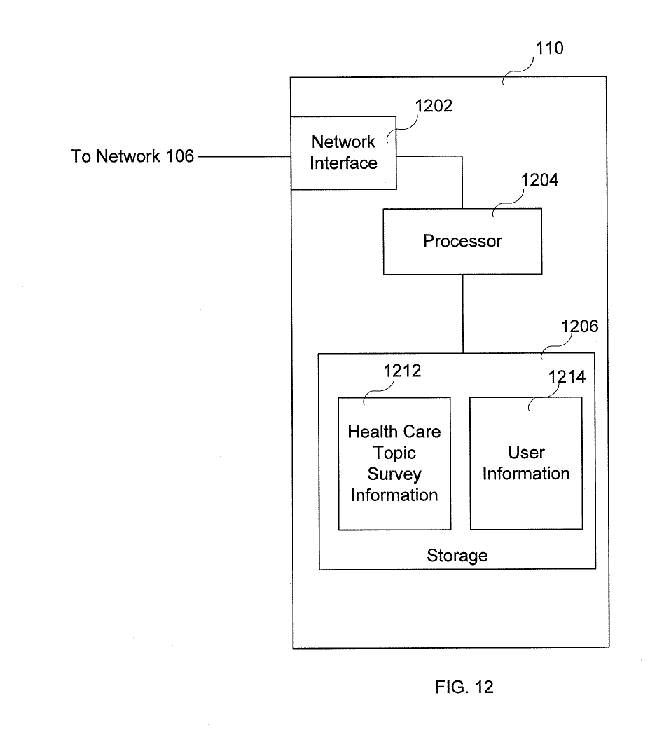

FIG. 12 illustrates a simplified diagram of an exemplary server, in accordance with an embodiment of the present invention. For explanatory purposes, FIG. 12 refers to the above-discussed FIG. 1. As illustrated, server 110 comprises a network interface 1202 for connecting to a network, such as network 106. Network interface 1202 may be any type of network interface, such as, for example, is commonly used in web servers.

Server 110 may further comprise a processor 1204 configured to manage operations of server 110. Processor 1204 may be, for example, a processor such as is commonly used in web servers. Processor 1204 may be responsible for executing code (also known as computer programs, software, software applications, applications, components, or code) for accessing the information stored by server 110 and generating web pages such as discussed above. This code may be embodied in machine instructions for a programmable processor, and may be implemented in a high-level procedural and/or object-oriented programming language, and/or in assembly/machine language.

Server 110 may further comprise a storage 1206 that may store the code and the information used for generating web pages, such as discussed above. Storage 1206 may be a computer readable medium, such as, for example, a computer readable medium commonly used in web servers. As used herein, the term “computer-readable medium” refers to any computer program product, apparatus and/or device (e.g., magnetic discs, optical disks, memory) used to provide machine instructions and/or data to a programmable processor.

As illustrated, storage 1206 may store survey information 1206 for a plurality of different health care topics, such as pregnancy, musculoskeletal, etc. As noted above, information 1206 may be organized as a relational database using an entity relationship mechanism such as discussed above with reference to FIG. 11.

Storage 1206 may further store user information 1214 that includes, for example, authentication information for the users, information associating users with a particular entity (e.g., company) as well as information regarding the health care plan(s) to which the user belongs or are available to the user, such as discussed above. The stored user information 1214 may be stored as a relational database using an entity relationship mechanism.

Embodiments of the present invention have been described with reference to several aspects of the present invention. It would be appreciated that embodiments described in the context of one aspect may be used in other aspects without departing from the scope of the present invention.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart there from.

What is claimed is:

1. A method for providing healthcare information to a user, the method comprising:
receiving, via a network, authentication information identifying the user as a customer of health care services associated with a particular entity;
associating the user with the particular entity if the authentication information corresponds to stored authentication information associating the user with the particular entity;
receiving from the user, via the network, information identifying a healthcare issue; and
generating a user interface to be displayed to the user, via the network, wherein the user interface comprises comparison information regarding the health care issue to enable the user to make a decision regarding selecting a treatment option from a plurality of treatment options for treating the healthcare issue; and
wherein the comparison information comprises information for each of the plurality of treatment options gathered from a plurality of individuals that used at least one of the plurality of treatment options in treating the healthcare issue such that the comparison information enables the user to compare the plurality of treatment options; and
wherein at least one of the plurality of treatment options is provided via healthcare services provided by the entity, and wherein the user interface further comprises information regarding the healthcare services provided to the user by the entity.

2. The method of claim 1, wherein the comparison information gathered from the plurality of individuals comprises information gathered using a statistical survey of the plurality of individuals.

3. The method of claim 2, wherein the plurality of individuals from which the information was gathered comprises individuals treated with at least one of the plurality of treatment options.

4. The method of claim 3, wherein herein the plurality of individuals from which the information was gathered comprises medical professionals who personally faced the healthcare issue themselves and evaluated and used at least one of the plurality of treatment options on themselves when impacted by the healthcare issue.

5. The method of claim 1, further comprising:
determining a cost to the user for at least one of the plurality of treatment options based on the health services provided to the user; and
wherein the comparison information further comprises the determined cost for the treatment option.

6. The method of claim 1, wherein the comparison information gathered from the plurality of individuals comprises information regarding a percentage of individuals who used each treatment option.

7. The method of claim 1, wherein the user interface further comprises a link that a user may select to learn about the health care issue, the method further comprising:
receiving an indication that the user selected the link to learn about the health care issue; and
generating a learn user interface to be displayed to the user, via the network, wherein the learn user interface comprises general information regarding the health care issue and a plurality of questions for the individual to ask a doctor with regard to the health care issue.

8. The method of claim 1, wherein the user interface comprises a link that a user may select to obtain additional comparison information regarding the health care issue, the method further comprising:
receiving an indication that the user selected the link to obtain additional comparison information about the health care issue; and
generating a comparison user interface to be displayed to the user, via the network, wherein the comparison user interface comprises additional comparison information regarding the health care issue; and
wherein the additional comparison information comprises information for each of the plurality of treatment options gathered from a plurality of individuals that were treated with least one of the treatment options and a plurality of medical professionals who personally faced the healthcare issue themselves and evaluated and used at least one of the plurality of treatment options on themselves when impacted by the healthcare issue.

9. The method of claim 1, wherein the user interface comprises a link that a user may select to interact with others regarding the health care issue, the method further comprising:
receiving an indication that the user selected the link to interact with others regarding the health care issue; and
generating a connect user interface to be displayed to the user, via the network, wherein the connect user interface enables the user to interact with others regarding the health care issue.

10. The method of claim 1, wherein the user interface further comprises a link for at least one of the plurality of treatment options that a user may select to take an action with regard to the treatment option.

11. The method of claim 10, wherein the action comprises communicating with a medical professional regarding the treatment option.

12. The method of claim 10, wherein the action comprises placing an order for a product associated with the treatment option.

13. A system configured to provide healthcare information to a user, the system comprising:
a storage containing authentication information identifying the user as a customer of health care services associated with a particular entity, information regarding a plurality of treatment options for a health care issue and comparison information to enable the user to compare the plurality of treatment options;
a network interface configured to connect to a network and receive, via the network, the authentication information from the user and
a processor configured to associate the user with the particular entity if the received authentication information corresponds to the stored authentication information, receiving from the user, via the network interface, information identifying a healthcare issue, and generate a user interface to be displayed to the user, via the network, wherein the user interface comprises comparison information regarding the health care issue to enable the user to make a decision regarding selecting a treatment option from a plurality of treatment options for treating the healthcare issue; and
wherein the comparison information comprises information for each of the plurality of treatment options gathered from a plurality of individuals that used at least one of the plurality of treatment options in treating the healthcare issue such that the comparison information enables the user to compare the plurality of treatment options; and
wherein at least one of the plurality of treatment options is provided via healthcare services provided by the entity, and wherein the user interface further comprises information regarding the healthcare services provided to the user by the entity.

14. The system of claim 13, wherein the comparison information gathered from the plurality of individuals comprises information gathered using a statistical survey of the plurality of individuals.

15. The system of claim 14, wherein the plurality of individuals from which the information was gathered comprises individuals treated with at least one of the plurality of treatment options.

16. The system of claim 14, wherein herein the plurality of individuals from which the information was gathered comprises medical professionals who personally faced the healthcare issue themselves and evaluated and used at least one of the plurality of treatment options on themselves when impacted by the healthcare issue.

17. The system of claim 14 wherein the processor is further configured to determine a cost to the user for at least one of the plurality of treatment options based on the health services provided to the user; and
wherein the comparison information further comprises the determined cost for the treatment option.

18. The system of claim 13, wherein the user interface further comprises a link that a user may select to learn about the health care issue, and
wherein the processor is further configured to receive an indication that the user selected the link to learn about the health care issue; and generate a learn user interface to be displayed to the user, via the network, wherein the learn user interface comprises general information regarding the health care issue and a plurality of questions for the individual to ask a doctor with regard to the health care issue.

19. The system of claim 13, wherein the user interface comprises a link that a user may select to obtain additional comparison information regarding the health care issue; and
wherein the processor is further configured to receive an indication that the user selected the link to obtain additional comparison information about the health care issue; and generate a comparison user interface to be displayed to the user, via the network, wherein the comparison user interface comprises additional comparison information regarding the health care issue; and
wherein the additional comparison information comprises information for each of the plurality of treatment options gathered from a plurality of individuals that were treated with least one of the treatment options and a plurality of medical professionals who personally faced the healthcare issue themselves and evaluated and used at least one of the plurality of treatment options on themselves when impacted by the healthcare issue.

20. The system of claim 13, wherein the user interface comprises a link that a user may select to interact with others regarding the health care issue; and
wherein the processor is further configured to receive an indication that the user selected the link to interact with others regarding the health care issue; and generate a connect user interface to be displayed to the user, via the network, wherein the connect user interface enables the user to interact with others regarding the health care issue.

21. A system for providing healthcare information to a user, the system comprising:
means for receiving, via a network, authentication information identifying the user as a customer of health care services associated with a particular entity;
means for associating the user with the particular entity if the authentication information corresponds to stored authentication information associating the user with the particular entity;
means for receiving from the user, via the network, information identifying a healthcare issue; and
means for generating a user interface to be displayed to the user, via the network, wherein the user interface comprises comparison information regarding the health care issue to enable the user to make a decision regarding selecting a treatment option from a plurality of treatment options for treating the healthcare issue; and
wherein the comparison information comprises information for each of the plurality of treatment options gathered from a plurality of individuals that used at least one of the plurality of treatment options in treating the healthcare issue such that the comparison information enables the user to compare the plurality of treatment options; and
wherein at least one of the plurality of treatment options is provided via healthcare services provided by the entity, and wherein the user interface further comprises information regarding the healthcare services provided to the user by the entity.
